(19) United States
(12) Patent Application Publication
(10) Pub. No.: US 2022/0375227 A1
(43) Pub. Date: Nov. 24, 2022

(54) COUNTING SYSTEM, COUNTING METHOD, AND PROGRAM

(71) Applicant: NEC Corporation, Minato-ku, Tokyo (JP)

(72) Inventor: Kentaro ITO, TOKYO (JP)

(73) Assignee: NEC Corporation, Minato-ku, Tokyo (JP)

(21) Appl. No.: 17/782,902

(22) PCT Filed: Oct. 29, 2020
(86) PCT No.: PCT/JP2020/040642

§ 371 Date: Jun. 6, 2022

(30) Foreign Application Priority Data
Dec. 19, 2019 (JP) 2019-228949

(51) Int. Cl. G06V 20/52; G06T 7/20; G06V 40/10

(52) U.S. Cl. CPC G06V 20/53; G06T 7/20; G06V 40/103; G06T 2207/30232; G06T 2207/30242

(57) ABSTRACT

A counting system 100 of the present invention includes an image acquisition means 121 for acquiring a captured image obtained by capturing an imaging area that is a partial area of an object area, a detection means 122 for detecting a person existing in the imaging area from the captured image, a measurement means 123 for, on the basis of a detection result of the person, measuring a staying time that is a period of time in which the person stays in the imaging area, and a calculation means 124 for, on the basis of the detection result of the person and the staying time, calculating the number of persons existing in the object area.

### TECHNICAL FIELD

The present invention relates to a counting system, a counting method, and a program for counting persons in an object area.

### BACKGROUND ART

In an area where a large number of persons exist such as a shopping district, an event site, or a facility, it is necessary to count the number of persons in order to appropriately cope with marketing, guiding of persons, and securities in such an area. For example, Patent Literature 1 discloses performing image processing based on a frame image captured by a fixed camera to estimate the number of persons passing through the imaging area.
Patent Literature 1: JP 2014-6655 A

### SUMMARY

However, in an area such as a shopping district, an event site, or a facility, a plurality of entrances and exits may exist. Therefore, capturing images with cameras at all entrances and exits and counting the number of persons is difficult and costly. This causes a problem that it is difficult to count the number of persons more accurately.

Meanwhile, in order to count the number of persons more accurately, it can also be considered to image the entire object area with cameras. However, imaging the entire object area is difficult and costly. Further, in the case of a shopping district described above, there are shops therein, and persons may exist in the shops. Therefore, even if the entire object area is imaged with cameras, it is impossible to measure the persons existing in the shops, so that it is difficult to count the accurate number of persons. Such a problem may be caused in any areas such as event sites and facilities.

It is also considered to count the number of persons by identifying the persons existing in an area. However, since identifying persons may cause a privacy problem, it is difficult to realize.

As a result, there is a problem that it is difficult to count the number of persons existing in an object area more accurately, while suppressing a problem of personal privacy and a problem of cost increase. In view of the above, an object of the present invention is to provide a counting system capable of solving such problems.

A counting method according to one aspect of the present invention is configured to include

acquiring a captured image obtained by capturing an imaging area that is a partial area of an object area;

detecting a person existing in the imaging area from the captured image;

on the basis of a detection result of the person, measuring a staying time that is a period of time in which the person stays in the imaging area; and

on the basis of the detection result of the person and the staying time, calculating the number of persons existing in the object area.

A counting system according to one aspect of the present invention is configured to include

an image acquisition means for acquiring a captured image obtained by capturing an imaging area that is a partial area of an object area;

a detection means for detecting a person existing in the imaging area from the captured image;

a measurement means for, on the basis of a detection result of the person, measuring a staying time that is a period of time in which the person stays in the imaging area; and

a calculation means for, on the basis of the detection result of the person and the staying time, calculating the number of persons existing in the object area.

A program according to one aspect of the present invention is configured to cause a processor of an information processing device to execute processing to:

acquire a captured image obtained by capturing an imaging area that is a partial area of an object area;

detect a person existing in the imaging area from the captured image;

on the basis of a detection result of the person, measure a staying time that is a period of time in which the person stays in the imaging area; and

on the basis of the detection result of the person and the staying time, calculate the number of persons existing in the object area.

With the configurations described above, the present invention enables counting the number of persons existing in an object area, while suppressing a problem of personal privacy and a problem of cost increase.

### BRIEF DESCRIPTION OF DRAWINGS

FIG. 1 is a block diagram illustrating the overall configuration of a counting system according to a first exemplary embodiment of the present invention.

FIG. 2 is a block diagram illustrating a configuration of a counting device disclosed in

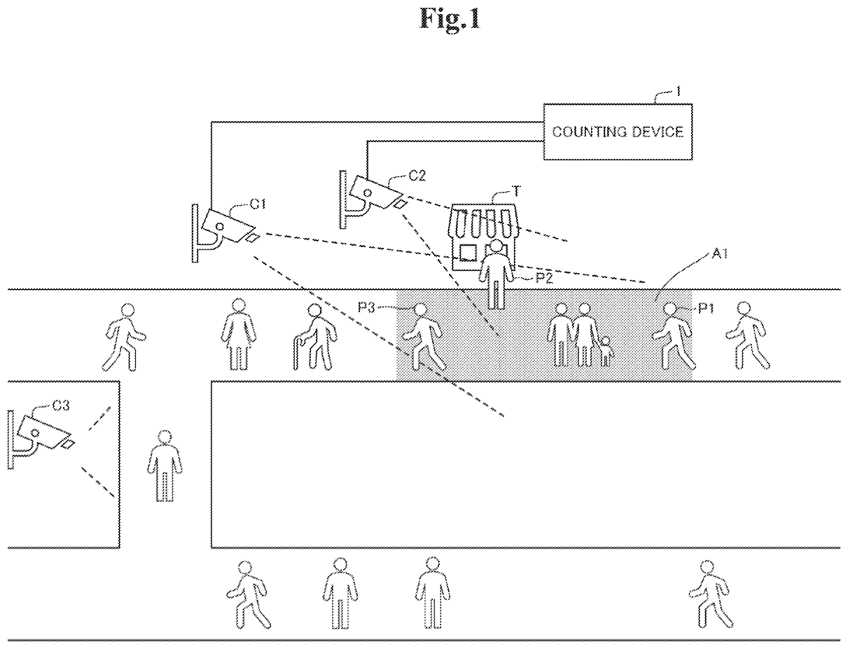

FIG. 1.

FIG. 3 illustrates a state of processing by the counting device disclosed in FIG. 1.

FIG. 4 illustrates a state of processing by the counting device disclosed in FIG. 1.

FIG. 5 illustrates a state of processing by the counting device disclosed in FIG. 1.

FIG. 6 is a flowchart illustrating a processing operation by the counting device disclosed in FIG. 1.

FIG. 7 is a flowchart illustrating a processing operation by the counting device disclosed in FIG. 1.

FIG. 8 is a flowchart illustrating a processing operation by the counting device disclosed in FIG. 1.

FIG. 9 is a block diagram illustrating a hardware configuration of a counting system according to a second exemplary embodiment of the present invention.

FIG. 10 is a block diagram illustrating a configuration of the counting system according to the second exemplary embodiment of the present invention.

FIG. 11 is a flowchart illustrating an operation of the counting system according to the second exemplary embodiment of the present invention.

### EXEMPLARY EMBODIMENTS

### First Exemplary Embodiment

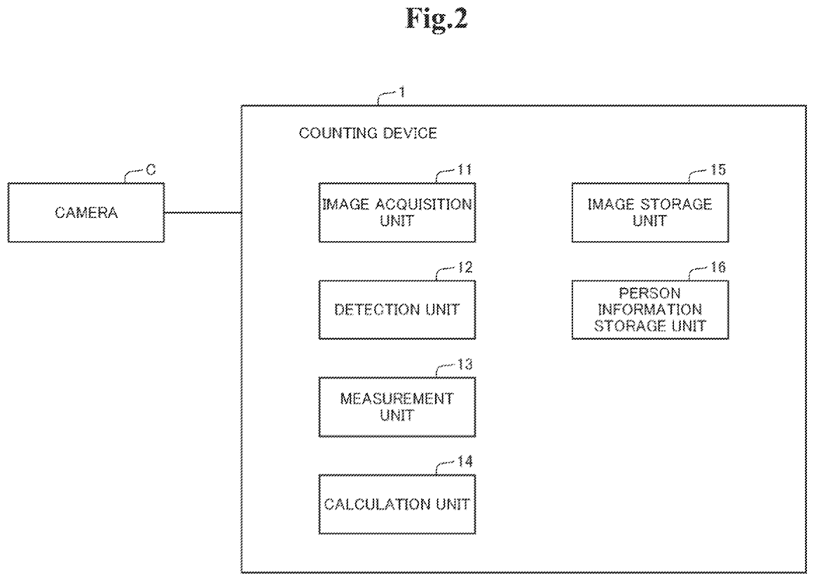

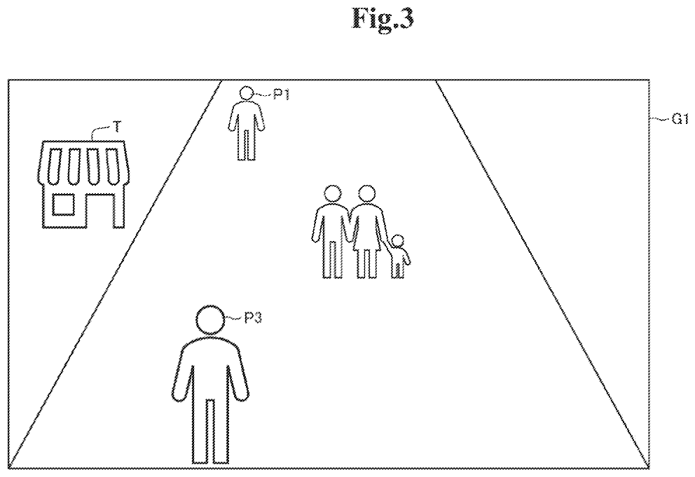

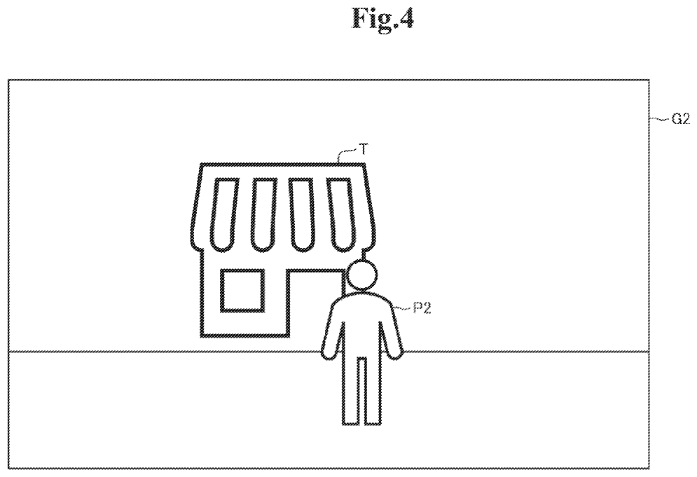

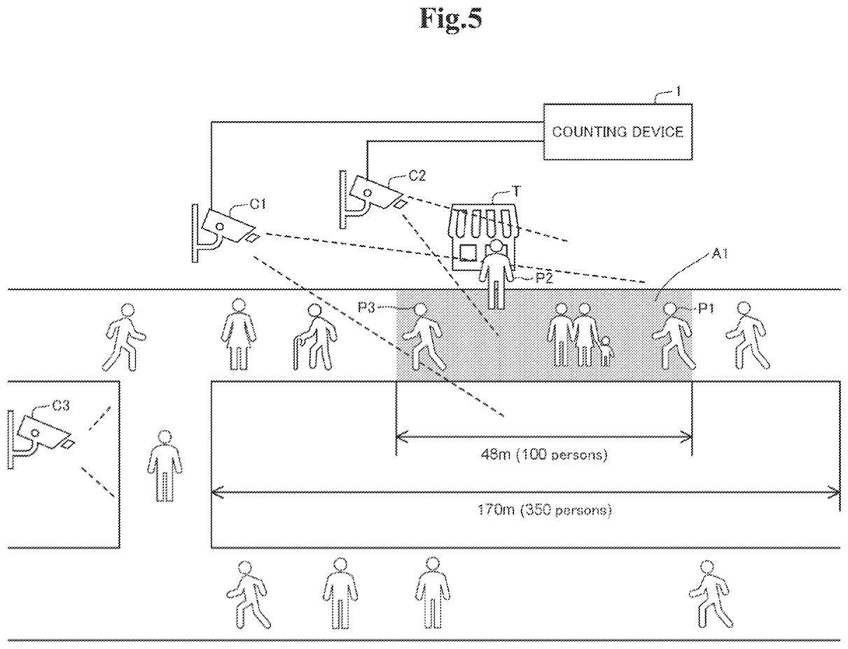

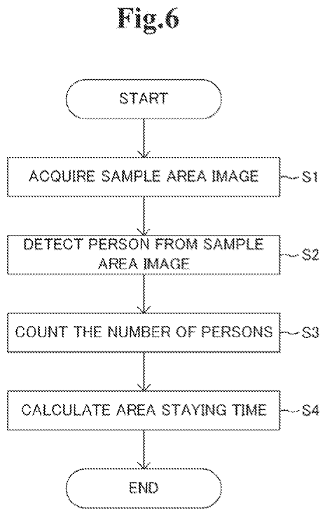

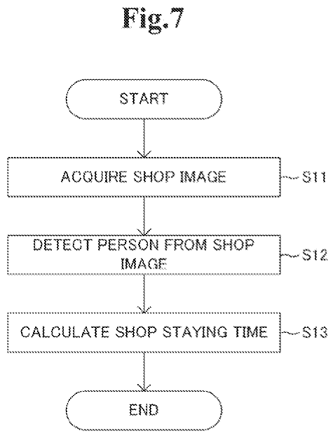

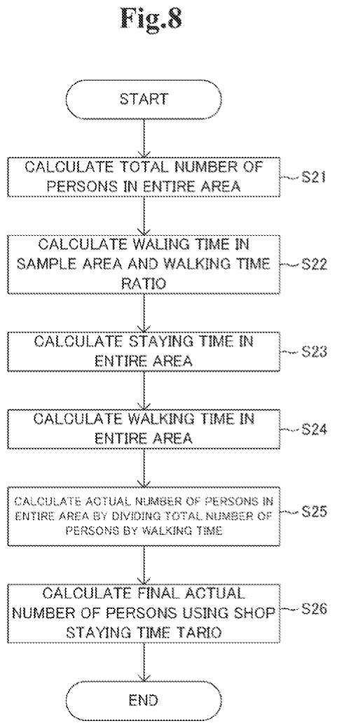

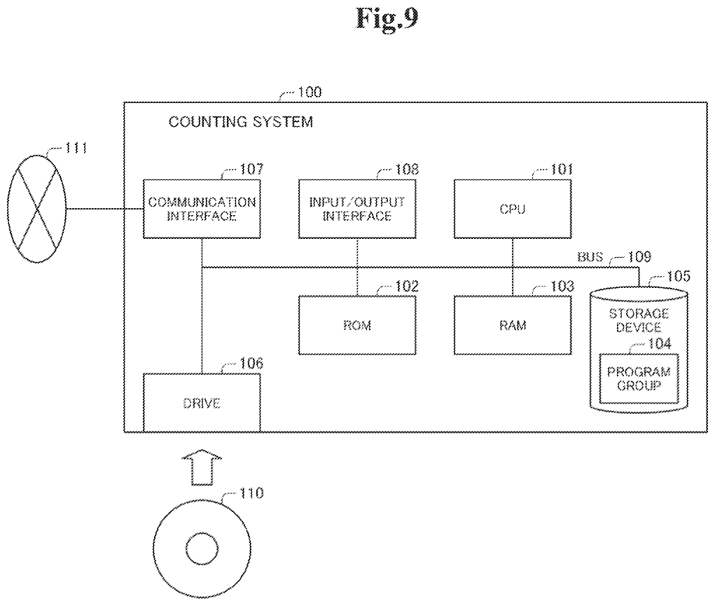

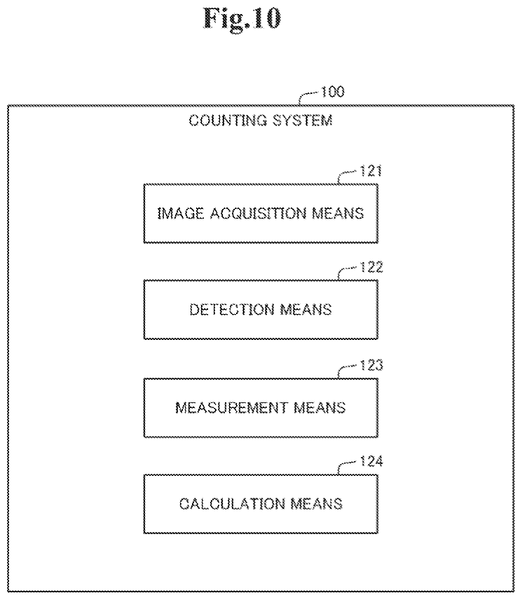

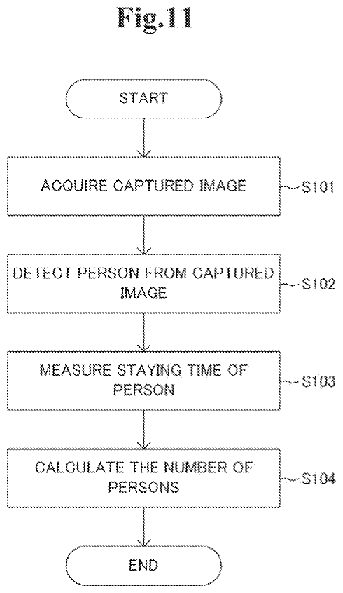

A first exemplary embodiment of the present invention will be described with reference to FIGS. 1 to 8. FIGS. 1 and 2 are diagrams for explaining a configuration of a counting system, and FIGS. 3 to 8 are illustrations for explaining the processing operation of the counting system.

The counting system of the present invention is a system whose object area is a shopping district and which is used for counting the number of persons visiting the shopping district. In particular, the counting system of the present invention is configured to count the number of persons in the entire shopping district using a captured image of a partial area, without capturing images of the entire area of the shopping district. However, the area in which the number of persons is counted by the counting system of the present invention is not limited to a shopping district. Objects of the system may be any areas in which a large number of persons visit, such as event sites and facilities.

[Configuration]

As illustrated in FIG. 1, the counting system of the present invention includes cameras C1, C2, and C3 that capture images inside a shopping district that is an object area, and a counting device 1 that counts the number of persons visiting the shopping district by processing images captured by the cameras C1, C2, and C3.

Among the cameras C1, C2, and C3, the cameras C1 and C3 capture images of imaging areas set as sample areas that are partial areas in the shopping district. The camera C2 captures images of a specific area near the entrance of a shop T existing in the shopping district. Specifically, as illustrated in FIG. 1, the camera C1 is installed so as to capture a sample area A1 set in a walking area such as an area on a street on which persons walk in the shopping district. It is assumed that the sample area A1 is set in a partial area of a street among a plurality of streets in the shopping district, and that there are other sample areas in which cameras, not illustrated, are installed. However, sample areas are set only in partial areas, and are not set is all areas of the streets in the shopping district. As illustrated in FIG. 1, the camera C2 is installed so as to capture the vicinity of the entrance of the shop T existing in the sample area A1. When there is another shop in the sample area A, it is assumed that another camera is installed corresponding to the other shop.

FIGS. 3 and 4 illustrate examples of images captured by the cameras C1 and C2. FIG. 3 illustrates a sample area image G1 (walking area image) obtained by capturing the sample area A1 by the camera C1, and persons P1 and P3 existing in the sample area A1 are shown. FIG. 4 illustrates a shop image G2 (specific area image) obtained by capturing the vicinity of the entrance of the shop T in the sample area A1 by the camera C2, and a person P2 who goes in and out of the shop T is shown.

Next, the counting device 1 will be described. The counting device 1 is configured of one or a plurality of information processing devices each having an arithmetic device (processor) and a storage device. As illustrated in FIG. 2, the counting device 1 includes an image acquisition unit 11, a detection unit 12, a measurement unit 13, and a calculation unit 14 that are constructed by execution of a program by the arithmetic device. The counting device 1 also includes an image storage unit 15 and a person information storage unit 16 formed in the storage device. Hereinafter, each configuration will be described in detail.

The image acquisition unit 11 (image acquisition means) receives images captured by the cameras C1 and C2 as described above, and stores them in the image storage unit 15. Specifically, the image acquisition unit 11 receives, from the camera C1, the sample area image G1 as illustrated in FIG. 3 captured by the camera C1, receives, from the camera C2, the shop image G2 captured by the camera C2, and stores them in the image storage unit 15. Since the camera C1 and the camera C2 are installed corresponding to the same sample area A1, the image acquisition unit 11 stores the sample area image G1 captured by the camera C1 and the shop image G2 captured by the camera C2 in association with each other in the image storage unit 15.

The image acquisition unit 11 also receives sample area images and shop images captured by cameras installed in other sample areas (not illustrated), and stores them in association with each other for each sample area in the image storage unit 15.

The detection unit 12 (detection means) reads the captured images G1 and G2 captured by the cameras C1 and C2 as described above from the image storage unit 15, and performs detection processing to detect persons from the captured images G1 and G2. Specifically, the detection unit 12 first detects persons from the sample area image G1 within a certain time such as one minute for example, and counts the number of the persons. The detection unit 12 detects persons from the features such as movements, shapes, and colors of objects in the sample area image G1. Then, the detection unit 12 counts the number of persons detected within a certain time, and stores the number of persons together with time information in the person information storage unit 16.

The detection unit 12 also detects states of persons shown in the sample area image G1 and stores them in the person information storage unit 16. Specifically, when detecting a person who newly appears in the sample area image G1, that is, when detecting a person who newly moves in the frame of the sample area image G1, the detection unit 12 stores the time when the person is detected in association with the person information. Further, when detecting that a person disappears from the sample area image G1, that is, when detecting a person who moves out of the frame of the sample area image G1, the detection unit 12 stores the time when the person disappears in association with the person information. For example, as illustrated in FIG. 3, when the person P1 newly appears on the deep side in the sample area image G1, the detection unit 12 stores the time when the person P1 is detected together with the person information for identifying the person P1, and when the person P3 disappears from the front side in the sample area image G1, the detection unit 12 stores the time when the person P3 disappears together with the person information for identifying the person P3. Note that the detection unit 12 may detect a person who newly appears from any direction in the sample area image G1 and store the time thereof, and detect a person who disappears in any direction and store the time thereof.

As similar to the above, the detection unit 12 also detects the state of a person shown in the shop image G2 and stores it in the person information storage unit 16. Specifically, when detecting that a person disappears from the shop image G2, the detection unit stores the time when the person disappears in association with the person information, and when detects a person who newly appears in the shop image G2, the detection unit 12 stores the time when the person is detected in association with the person information. For example, when the person P2 disappears from the state illustrated in FIG. 4 in the shop image G2 because he/she enters the shop T, the detection unit 12 stores the time when the person P2 disappears together with the person information for identifying the person P2 and then, when the person P2 appears in the shop image G2 as illustrated in FIG. 4 because he/she leaves the shop T, the detection unit 12 stores the time when the person P2 is detected together with the person information for identifying the person P2. Note that the person P2 is handled on the assumption that a person leaves the shop in the sequence of entering the shop, and the time when a person leaves the shop is associated with person information specified according to the sequence of entering the shop. As an example, it is assumed that when three persons enter the shop in sequence, a person who entered the shop first leaves the shop first, and the entering time and the leaving time are associated with the person information of the person.

The measurement unit 13 (measurement means) uses the detection result of the person described above to measure the staying time that the person stays in the shopping district. At that time, the measurement unit 13 calculates an area staying time (imaging area staying time) that is a period of time in which a person stays in the sample area A1, and a shop staying time (specific area staying time) that is a period of time in which a person stays at the shop T. Specifically, the measurement unit 13 first reads, from the person information storage unit 16, the time when a person enters the sample area A1 (the time newly detected in the sample area image G1) and the time when the person leaves the sample area A1 (the time when the person disappears from the sample area image G1), and uses the difference as an area staying time of the person. Then, by calculating and adding the area staying times of a plurality of persons, the measurement unit 13 calculates the total staying time in the sample area of the plurality of persons, and by dividing it by the total number of persons, the measurement unit 13 calculates the area staying time per person.

The measurement unit 13 also reads, from the person information storage unit 16, the time when a person enters the shop T (the time when the person disappears from the shop image G2) and the time when the person leaves the shop T (the time when the person appears in the shop image G2), and uses the difference as the shop staying time of the person. Then, by calculating and adding the shop staying times of a plurality of persons, the measurement unit 13 calculates the total staying time in the shop of the plurality of persons, and by dividing it by the total number of persons, the measurement unit 13 calculates the shop staying time per person.

The calculation unit 14 (calculation means) calculates the number of persons existing in the entire shopping district that is the object area, by using the area staying time and the shop staying time described above. Specifically, the calculation unit 14 calculates the number of persons existing in the entire shopping district according to the procedure described below.

First, the calculation unit 14 subtracts the shop staying time from the area staying time to calculate the walking time of a person in the sample area A1.

Walking time=area staying time−shop staying time

Then, the calculation unit 14 calculates the walking time ratio of the person in the sample area A1 by dividing the calculated walking time by the area staying time.

Walking time ratio=walking time/area staying time

Then, the calculation unit 14 handles the calculated walking time ratio as a walking time ratio of the persons in the entire shopping district that is the object area, rather than within the sample area A1. Then, the calculation unit 14 calculates the walking time (object area walking time) of the person in the entire shopping district, by multiplying the staying time of the person in the shopping district that is the object area by the walking time ratio.

Walking time of person in the entire shopping district=staying time of person in the entire shopping district×walking time ratio

Here, the calculation unit 14 calculates the staying time of the person in the entire shopping district required for calculating the walking time of the person in the entire shopping district as described below. At that time, the calculation unit 14 estimates the staying time of the person in another area in the shopping district from the area staying time calculated as described above from section estimation, and obtains the staying time of the person in the entire shopping district. Specifically, the calculation unit 14 divides the entire shopping district into some sections, handles some sections similarly to the sample area as described above, and calculates the area staying time of the sample area. Then, the calculation unit 14 calculates an average value of the area staying time of some sample areas by section estimation, uses the average value as the area staying time of another section that is not used as a sample area, and adds the area staying times of all sections including the sample area to calculate the staying time in the entire shopping district. However, the calculation unit 14 may perform calculation by any method, not limited to calculating the staying time of the person in the entire shopping district by the method described above. For example, the calculation unit 14 may use the area staying time in the sample area, described above, as it is as a value of another section to obtain the entire staying time.

Then, the calculation unit 14 calculates the total number of persons existing in the entire shopping district (the number of object area persons). At that time, the calculation unit 14 uses the number of persons detected in a certain time period in the sample area A1. Specifically, the calculation unit 14 first estimates the number of persons in a predetermined region from the walking speed of a person and a time interval for counting the number of persons. For example, when the walking speed of a person is assumed to be 0.8 m/s and the detected number of persons in one minute is 100 persons, as illustrated in FIG. 5, it can be calculated that the 100 persons exist in the range of 0.8 m/s×60s=48m. Then, as illustrated in FIG. 5, when the length of the street that is a larger area including the area of 48 m is 170 m, it is calculated that 100×(170/48)=350 persons. By calculating the number of persons on another street in the shopping district by using further information or by using the number of persons detected in another sample area, the total number of persons existing in the entire shopping district is calculated. Further, the calculation unit 14 calculates the total number of persons in the shopping district in a day by accumulating the number of persons described above for 12 hours in the day time or 24 hours that is the whole day.

Note that since detection is performed regularly without specifying a person from the sample area image G1 captured by the camera C1, the same person is counted in duplicate. Therefore, the number of persons existing in the entire shopping district calculated by using the number of persons detected in a certain time period in the sample area A as described above is the total number of person.

Then, the calculation unit 14 calculates the actual number of persons in the entire shopping district by dividing the total number of persons existing in the entire shopping district by the walking time of a person in the entire shopping district calculated as described above.

Actual number of persons in the entire shopping district=total number of persons existing in the entire shopping district/walking time of a person in the entire shopping district

Here, the actual number of persons in the entire shopping district calculated as described above does not taking into account the number of persons staying at the shop T. Therefore, the calculation unit 14 first calculates the shop staying time ratio representing the ratio of the staying time at the shop T to the staying time in the shopping district of a person. At that time, the calculation unit 14 may calculate, as the shop staying time ratio, a value obtained by dividing the shop staying time in the sample area A1 by the area staying time, and use such a value as it is as the shop staying time ratio in the entire shopping district. However, the calculation unit 14 may use, as the shop staying time ratio in the entire shopping district, an average value of the values obtained by dividing the shop staying time in a plurality of sample areas by the area staying time, or may calculate the shop staying time ratio by a still another calculation method.

Then, the calculation unit 14 calculates a correction value for the number of persons in the entire shopping district by using the following expression:

Correction value for the actual number of persons in the entire shopping district=the actual number of persons in the entire shopping district/(1−shop staying time ratio)

Thereby, the number of visitors of the shopping district in a day, including the number of persons staying at the shop, can be calculated.

[Operation]

Next, operation of the counting system in the present embodiment will be described with reference to the flowcharts of FIGS. 6 to 8 mainly. First, the counting device 1 acquires the sample area image G1 as illustrated in FIG. 3 captured by the camera C1 (step S1 of FIG. 6). Then, the counting device 1 performs detection processing to detect persons from the sample area image G1 (step S2 of FIG. 6). At that time, the counting device 1 detects persons in a certain period of time such as one minute for example, and counts the number of persons (step S3 of FIG. 6).

Further, the counting device 1 stores the time when a person newly appears in the sample area image G1 is detected and the time when disappearance of such a person from the sample area image G1 is detected. Then, from these times, the counting device 1 calculates the area staying time that is a period of time in which the person stays in the sample area A1 (step S4 of FIG. 6).

The counting device 1 also acquires the shop image G2 as illustrated in FIG. 4 captured by the camera C2 (step S11 of FIG. 7). Then, the counting device 1 performs detection processing to detect persons from the shop image G2 (step S12 of FIG. 7). At that time, the counting device 1 stores the time when disappearance of a person from the shop image G2 is detected and the time when a person appears again in the shop image G2 is detected. Then, from these times, the counting device 1 calculates the shop staying time that is a period of time in which the person stays at the shop T (step S13 of FIG. 7).

Then, the counting device 1 performs processing to calculate the number of persons in the entire shopping district. First, the counting device 1 calculates the total number of persons existing in the entire shopping district (the number of object area persons) (step S21 of FIG. 8). For example, from the number of persons detected in a certain period of time in the sample area A1, the counting device 1 estimates the number of persons existing near the sample area A1 by using the walking speed of a person and a time interval for counting the number of persons, and further estimates the number of persons existing in the entire shopping district. Note that the estimated number of persons existing in the entire shopping district is the total number of persons.

Then, the counting device 1 subtracts the shop staying time from the area staying time to calculate the walking time of a person in the sample area A1 (step S22 of FIG. 8). Furthermore, the counting device 1 calculates the walking time ratio of a person in the sample area A1 by dividing the calculated walking time by the area staying time (step S22 of FIG. 8). Note that the counting device 1 handles the calculated walking time ratio as the walking time ratio of a person in the entire shopping district.

Then, the counting device 1 estimates the staying time of a person in another area in the shopping district from the area staying time in the sample area A1 by section estimation, and calculates the staying time of a person in the entire shopping district (step S23 of FIG. 8). Then, the counting device 1 calculates the walking time of a person in the entire shopping district, by multiplying the staying time of a person in the shopping district by the walking time ratio (step S24 of FIG. 8).

Then, the counting device 1 calculates the actual number of persons in the entire shopping district by dividing the total number of persons existing in the entire shopping district by the walking time of a persons in the entire shopping district (step S25 of FIG. 8). Here, the counting device 1 calculates the shop staying time ratio representing the ratio of the staying time at the shop T to the staying time in the shopping district of a person. Then, as described above, the counting device 1 divides the actual number of persons in the entire shopping district calculated as described above by (1−shop staying time ratio) to thereby calculate the actual number of persons in the entire shopping district including the number of persons staying at the ship T (step S26 of FIG. 8).

As described above, in the present invention, it is possible to calculate the number of persons in the entire shopping district using a captured image in a sample area that is a partial area, without imaging the entire object area such as a shopping district, and without specifying persons. In particular, in the present invention, by calculating the walking time of a person in the object area, it is possible to calculate the number of persons accurately. Further, in the present invention, it is possible to calculate the number of persons more accurately by taking into account the number of persons stopping by a particular area such as a shop existing in the shopping district. As a result, it is possible to count the number of persons existing in an object area more accurately, while suppressing a problem of personal privacy and a problem of cost increase.

### Second Exemplary Embodiment

Next, a second exemplary embodiment of the present invention will be described with reference to FIGS. 9 to 11. FIGS. 9 and 10 are block diagrams illustrating the configuration of a counting system according to the second exemplary embodiment, and FIG. 11 is a flowchart illustrating the operation of the counting system. Note that the present embodiment shows the outlines of the configurations of the counting device 1 and the counting method described in the first exemplary embodiment.

First, a hardware configuration of the counting system 100 in the present embodiment will be described with reference to FIG. 9. The counting system 100 is configured of at least one typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 303
Storage device 105 storing therein the program group 304
Drive 106 that performs reading and writing on a storage medium 110 outside the information processing device
Communication interface 107 connecting to a communication network 111 outside the information processing device
Input/output interface 108 for performing input/output of data
Bus 109 connecting the constituent elements

The counting system 100 can construct, and can be equipped with, an image acquisition means 121, a detection means 122, a measurement means 123, and a calculation means 124 illustrated in FIG. 11 through acquisition and execution of the program group 104 by the CPU 101. Note that the program group 104 is stored in the storage device 105 or the ROM 102 in advance, and is loaded to the RAM 103 by the CPU 101 as needed. Further, the program group 104 may be provided to the CPU 101 via the communication network 111, or may be stored on a storage medium 110 in advance and read out by the drive 106 and supplied to the CPU 101. However, the image acquisition means 121, the detection means 122, the measurement means 123, and the calculation means 124 may be constructed by electronic circuits.

Note that FIG. 9 illustrates an example of a hardware configuration of the counting system 100. The hardware configuration of the counting system is not limited to that described above. For example, the counting system 100 may be configured of part of the configuration described above, such as without the drive 106.

The counting system 100 executes the counting method illustrated in the flowchart of FIG. 11, by the functions of the image acquisition means 121, the detection means 122, the measurement means 123, and the calculation means 124 constructed by the program as described above.

As illustrated in FIG. 11, the counting system 100

acquires a captured image obtained by capturing an imaging area that is a partial area of an object area (step S101),

detects a person existing in the imaging area from the captured image (step S102),

on the basis of a detection result of the person, measuring a staying time that is a period of time in which the person stays in the imaging area (step S103), and

on the basis of the detection result of the person and the staying time, calculates the number of persons existing in the object area (step S104).

Since the present embodiment is configured as described above, it is possible to calculate the number of persons in the object area using a captured image of a partial area without imaging the entire object area, and without identifying the persons. As a result, it is possible to count the number of persons existing in the object area more accurately, while suppressing a problem of personal privacy and a problem of cost increase.

<Supplementary Notes>

The whole or part of the exemplary embodiments disclosed above can be described as the following supplementary notes. Hereinafter, outlines of the configurations of a counting system, a counting method, and a program, according to the present invention, will be described. However, the present invention is not limited to the configurations described below.

### (Supplementary Note 1)

A counting method comprising:

acquiring a captured image obtained by capturing an imaging area that is a partial area of an object area;

detecting a person existing in the imaging area from the captured image;

on a basis of a detection result of the person, measuring a staying time that is a period of time in which the person stays in the imaging area; and

on a basis of the detection result of the person and the staying time, calculating a number of persons existing in the object area.

### (Supplementary Note 2)

The counting method according to supplementary note 1, further comprising

measuring the staying time on a basis of a state in which the person is shown in the captured image.

### (Supplementary Note 3)

The counting method according to supplementary note 2, further comprising

measuring the staying time on a basis of a time when the person appears in the captured image and a time when the person disappears from the captured image.

### (Supplementary Note 4)

The counting method according to any of supplementary notes 1 to 3, further comprising

as the staying time, measuring an imaging area staying time that is a period of time in which the person stays in the imaging area, and a specific area staying time that is a period of time in which the person stays in a predetermined specific area within the imaging area.

### (Supplementary Note 5)

The counting method according to supplementary note 4, further comprising:

acquiring a walking area image obtained by capturing an area in which the person walks within the imaging area, and a specific area image obtained by capturing the specific area, as the captured images;

detecting the person from the walking area image and detecting the person from the specific area image; and

measuring the imaging area staying time on a basis of the detection result of the person from the walking area image, and measuring the specific area staying time on a basis of the detection result of the person from the specific area image.

### (Supplementary Note 6)

The counting method according to any of supplementary notes 1 to 5, further comprising:

detecting a number of the persons existing in the imaging area; and

calculating the walking time of the person on a basis of the staying time, and calculating the number of persons staying in the object area on a basis of the number of the persons existing in the imaging area and the walking time.

### (Supplementary Note 7)

The counting method according to supplementary note 4 or 5, further comprising:

detecting a number of the persons existing in the imaging area; and

calculating the walking time of the person on a basis of the imaging area staying time and the specific area staying time, and calculating the number of persons existing in the object area on a basis of the number of the persons existing in the imaging area and the walking time.

### (Supplementary Note 8)

The counting method according to supplementary note 7, further comprising

calculating a number of object area persons representing the number of the persons existing in the object area on a basis of the number of the persons existing in the imaging area, calculating an object area walking time representing the walking time of the person in the object area on a basis of the walking time, and calculating the number of the persons existing in the object area by dividing the number of the object area persons by the object area walking time.

### (Supplementary Note 9)

The counting method according to supplementary note 7 or 8, further comprising:

calculating a ratio of a time in which the person stays at the specific area to a time in which the person stays in the imaging area on a basis of the specific area staying time, and further calculating the number of the persons on a basis of the ratio and a calculation result of the number of the persons existing in the object area.

### (Supplementary Note 10)

A counting system comprising:

image acquisition means for acquiring a captured image obtained by capturing an imaging area that is a partial area of an object area;

detection means for detecting a person existing in the imaging area from the captured image;

measurement means for, on a basis of a detection result of the person, measuring a staying time that is a period of time in which the person stays in the imaging area; and

calculation means for, on a basis of the detection result of the person and the staying time, calculating a number of persons existing in the object area.

### (Supplementary Note 11)

The counting system according to supplementary note 10, wherein

the measurement means measures the staying time on a basis of a state in which the person is shown in the captured image.

### (Supplementary Note 12)

The counting system according to supplementary note 11, wherein

the measurement means measures the staying time on a basis of a time when the person appears in the captured image and a time when the person disappears from the captured image.

### (Supplementary Note 13)

The counting system according to any of supplementary notes 10 to 12, wherein

as the staying time, the measurement means measures an imaging area staying time that is a period of time in which the person stays in the imaging area, and a specific area staying time that is a period of time in which the person stays in a predetermined specific area within the imaging area.

### (Supplementary Note 14)

The counting system according to supplementary note 13, wherein

the image acquisition means acquires a walking area image obtained by capturing an area in which the person walks within the imaging area, and a specific area image obtained by capturing the specific area, as the captured images,

the detection means detects the person from the walking area image and detects the person from the specific area image, and

the measurement means measures the imaging area staying time on a basis of the detection result of the person from the walking area image, and measures the specific area staying time on a basis of the detection result of the person from the specific area image.

### (Supplementary Note 15)

The counting system according to any of supplementary notes 10 to 14, wherein

the detection means detects a number of the persons existing in the imaging area, and

the calculation means calculates the walking time of the person on a basis of the staying time, and calculates the number of persons staying in the object area on a basis of the number of the persons existing in the imaging area and the walking time.

### (Supplementary Note 16)

The counting system according to supplementary note 13 or 14, wherein

the detection means detects a number of the persons existing in the imaging area, and

the calculation means calculates the walking time of the person on a basis of the imaging area staying time and the specific area staying time, and calculates the number of persons existing in the object area on a basis of the number of the persons existing in the imaging area and the walking time.

### (Supplementary Note 17)

The counting system according to supplementary note 16, wherein

the calculation means calculates a number of object area persons representing the number of the persons existing in the object area on a basis of the number of the persons existing in the imaging area, calculates an object area walking time representing the walking time of the person in the object area on a basis of the walking time, and calculates the number of the persons existing in the object area by dividing the number of the object area persons by the object area walking time.

### (Supplementary Note 18)

The counting system according to supplementary note 16 or 17, wherein

the calculation means calculates a ratio of a time in which the person stays at the specific area to a time in which the person stays in the imaging area on a basis of the specific area staying time, and further calculates the number of the persons on a basis of the ratio and a calculation result of the number of the persons existing in the object area.

### (Supplementary Note 19)

A computer-readable storage medium storing thereon a program for causing a processor of an information processing device to execute processing to:

acquire a captured image obtained by capturing an imaging area that is a partial area of an object area;

detect a person existing in the imaging area from the captured image;

on a basis of a detection result of the person, measure a staying time that is a period of time in which the person stays in the imaging area; and

on a basis of the detection result of the person and the staying time, calculate a number of persons existing in the object area.

Note that the program described above can be supplied to a computer by being stored on a non-transitory computer-readable medium of any type. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, a mask ROM, a PROM (Programmable ROM), an EPROM (Erasable PROM), a flash ROM, and a RAM (Random Access Memory)). Note that the program may be supplied to a computer by being stored in a transitory computer-readable medium of any type. Examples of transitory computer-readable media include electric signals, optical signals, and electromagnetic waves. A transitory computer-readable medium can be supplied to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2019-228949, filed on Dec. 19, 2019, the disclosure of which is incorporated herein in its entirety by reference.

### REFERENCE SIGNS LIST

1 counting device
11 image acquisition unit
12 detection unit
13 measurement unit
14 calculation unit
15 image storage unit
16 person information storage unit
A1 sample area
C1, C2, C3 camera
P1, P2, P3 person
T shop
100 counting system
101 CPU
102 ROM
103 RAM
104 program group
105 storage device
106 drive
107 communication interface
108 input/output interface
109 bus
110 storage medium
111 communication network
121 image acquisition means
122 detection means
123 measurement means
124 calculation means

What is claimed is:

1. A counting method comprising:
acquiring a captured image obtained by capturing an imaging area that is a partial area of an object area;
detecting a person existing in the imaging area from the captured image;
on a basis of a detection result of the person, measuring a staying time that is a period of time in which the person stays in the imaging area; and
on a basis of the detection result of the person and the staying time, calculating a number of persons existing in the object area.

2. The counting method according to claim 1, further comprising
measuring the staying time on a basis of a state in which the person is shown in the captured image.

3. The counting method according to claim 2, further comprising
measuring the staying time on a basis of a time when the person appears in the captured image and a time when the person disappears from the captured image.

4. The counting method according to claim 1, further comprising
as the staying time, measuring an imaging area staying time that is a period of time in which the person stays in the imaging area, and a specific area staying time that is a period of time in which the person stays in a predetermined specific area within the imaging area.

5. The counting method according to claim 4, further comprising:
acquiring a walking area image obtained by capturing an area in which the person walks within the imaging area, and a specific area image obtained by capturing the specific area, as the captured images;
detecting the person from the walking area image and detecting the person from the specific area image; and
measuring the imaging area staying time on a basis of the detection result of the person from the walking area image, and measuring the specific area staying time on a basis of the detection result of the person from the specific area image.

6. The counting method according to claim 1, further comprising:
detecting a number of the persons existing in the imaging area; and
calculating the walking time of the person on a basis of the staying time, and calculating the number of persons staying in the object area on a basis of the number of the persons existing in the imaging area and the walking time.

7. The counting method according to claim 4, further comprising:
detecting a number of the persons existing in the imaging area; and
calculating the walking time of the person on a basis of the imaging area staying time and the specific area staying time, and calculating the number of persons existing in the object area on a basis of the number of the persons existing in the imaging area and the walking time.

8. The counting method according to claim 7, further comprising
calculating a number of object area persons representing the number of the persons existing in the object area on a basis of the number of the persons existing in the imaging area, calculating an object area walking time representing the walking time of the person in the object area on a basis of the walking time, and calculating the number of the persons existing in the object area by dividing the number of the object area persons by the object area walking time.

9. The counting method according to claim 7, further comprising:
calculating a ratio of a time in which the person stays at the specific area to a time in which the person stays in the imaging area on a basis of the specific area staying time, and further calculating the number of the persons on a basis of the ratio and a calculation result of the number of the persons existing in the object area.

10. A counting system comprising:
at least one memory configured to store instructions; and
at least one processor configured to execute instructions to
acquire a captured image obtained by capturing an imaging area that is a partial area of an object area;
detect a person existing in the imaging area from the captured image;
on a basis of a detection result of the person, measure a staying time that is a period of time in which the person stays in the imaging area; and
on a basis of the detection result of the person and the staying time, calculate a number of persons existing in the object area.

11. The counting system according to claim 10, wherein the at least one processor is configured to execute the instructions to
measure the staying time on a basis of a state in which the person is shown in the captured image.

12. The counting system according to claim 11, wherein the at least one processor is configured to execute the instructions to
measure the staying time on a basis of a time when the person appears in the captured image and a time when the person disappears from the captured image.

13. The counting system according to claim 10, wherein the at least one processor is configured to execute the instructions to
as the staying time, measure an imaging area staying time that is a period of time in which the person stays in the imaging area, and a specific area staying time that is a period of time in which the person stays in a predetermined specific area within the imaging area.

14. The counting system according to claim 13, wherein the at least one processor is configured to execute the instructions to:
acquire a walking area image obtained by capturing an area in which the person walks within the imaging area, and a specific area image obtained by capturing the specific area, as the captured, images;
detect the person from the walking area image and detect the person from the specific area, image; and
measure the imaging area staying time on a basis of the detection result of the person from the walking area image, and measure the specific area staying time on a basis of the detection result of the person from the specific area image.

15. The counting system according to claim 10, wherein the at least one processor is configured to execute the instructions to:
detect a number of the persons existing in the imaging, area; and
calculate the walking time of the person on a basis of the staying time, and calculate the number of persons staying in the object area on a basis of the number of the persons existing in the imaging area and the walking time.

16. The counting system according to claim 13, wherein the at least one processor is configured to execute the instructions to:
detect a number of the persons existing in the imaging, area; and
calculate the walking time of the person on a basis of the imaging area staying time and the specific area staying time, and calculate the number of persons existing in the object area on a basis of the number of the persons existing in the imaging area and the walking time.

17. The counting system according to claim 16, wherein the at least one processor is configured to execute the instructions to
calculate a number of object area persons representing the number of the persons existing in the object area on a basis of the number of the persons existing in the imaging area, calculate an object area walking time representing the walking time of the person in the object area on a basis of the walking time, and calculate the number of the persons existing in the object area by dividing the number of the object area persons by the object area walking time.

18. The counting system according to claim 16, wherein the at least one processor is configured to execute the instructions to
calculate a ratio of a time in which the person stays at the specific area to a time in which the person stays in the imaging area on a basis of the specific area staying time, and further calculate the number of the persons on a basis of the ratio and a calculation result of the number of the persons existing in the object area.

19. A non-transitory computer-readable storage medium storing thereon a program comprising instructions for causing a processor of an information processing device to execute processing to:
acquire a captured image obtained by capturing an imaging area that is a partial area of an object area;
detect a person existing in the imaging area from the captured image;
on a basis of a detection result of the person, measure a staying time that is a period of time in which the person stays in the imaging area; and
on a basis of the detection result of the person and the staying time, calculate a number of persons existing in the object area.
